(19) United States
(12) Patent Application Publication
(10) Pub. No.: US 2014/0244813 A1
(43) Pub. Date: Aug. 28, 2014

(54) SERVER CLUSTER INITIATION

(71) Applicants: Joseph McDonald, Lafayette, CO (US); Gil Yosef Ovadia, Karkus (IL)

(72) Inventors: Joseph McDonald, Lafayette, CO (US); Gil Yosef Ovadia, Karkus (IL)

(21) Appl. No.: 13/780,199

(22) Filed: Feb. 28, 2013

(51) Int. Cl. H04L 12/24; G06F 9/44

(52) U.S. Cl. CPC H04L 41/0806; G06F 9/4416
USPC 709/222

(57) ABSTRACT

According to an embodiment, a build server device includes a processor, data storage, and a plurality of modules including a receiving module, a generating module and an initiation module. The receiving module is configured to receive information regarding a server cluster including at least an indication of a front end server of the server cluster. The generating module is configured to generate a data set based on the received information. The initiation module is configured to provide the generated data set to the front end server, provide an instruction to the front end server to facilitate the front end server automatically initiating itself based on the generated data set.

### BACKGROUND

Cloud computing is being utilized on an increasing basis. One arrangement of computing devices to facilitate cloud computing, for example, is a server cluster. In many instances a server cluster is a combination of multiple servers that are interconnected in a manner that they appear to be a virtual unified computing resource. Server clusters are useful for enhancing computing resource availability, scalability or both.

One challenge associated with utilizing server clusters is that installing a server cluster tends to be a long and complex process. The individual servers of the cluster typically do not have anything pre-installed on them that facilitates the servers operating as the cluster. Although suggestions have been made for creating a template and applying the template to each server in the cluster, manual template installation for each server is still required. Additionally, a particular, sequential order of installation may be necessary for the template-based approach to work. Manual server cluster installation and initiation also includes the drawback of the possibility for human error at various points during the process.

### SUMMARY

According to an example embodiment, a build server device includes a processor, associated data storage, and a plurality of modules including a receiving module, a generating module and an initiation module. The receiving module is configured to receive information regarding a server cluster including at least an indication of a front end server of the server cluster. The generating module is configured to generate a data set based on the received information. The initiation module is configured to provide the generated data set to the front end server, provide an instruction to the front end server to facilitate the front end server initiating itself based on the generated data set, and to determine whether the front end server has initiated itself.

According to an example embodiment, a server cluster system includes a front end server and a plurality of other servers. The front end server includes a front end remote management processor that is configured to receive a data set from a build server device and to initiate the front end server based on the received data set. The plurality of other servers each include a remote management processor configured to receive an initiation instruction to initiate the other server based on the instruction and based on information from the front end server.

According to an example embodiment, a method of initiating a server cluster includes receiving information regarding a server cluster including at least an indication of a front end server of the server cluster and generating a data set based on the received information. The generated data set is provided to the front end server. An instruction is provided to the front end server to facilitate the front end server initiating itself based on the generated data set.

According to an example embodiment, a method of initiating a server cluster system includes receiving a data set at a front end server of the server cluster and automatically initiating the front end server based on the received data set. An initiation instruction is received at a plurality of other servers of the server cluster. The other servers automatically initiate themselves based on the received initiation instruction and based on information from the front end server.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a server cluster system designed according to an embodiment of this invention.

FIG. 2 is a flowchart diagram summarizing an example method of initiating a server cluster according to an embodiment of this invention.

### DETAILED DESCRIPTION

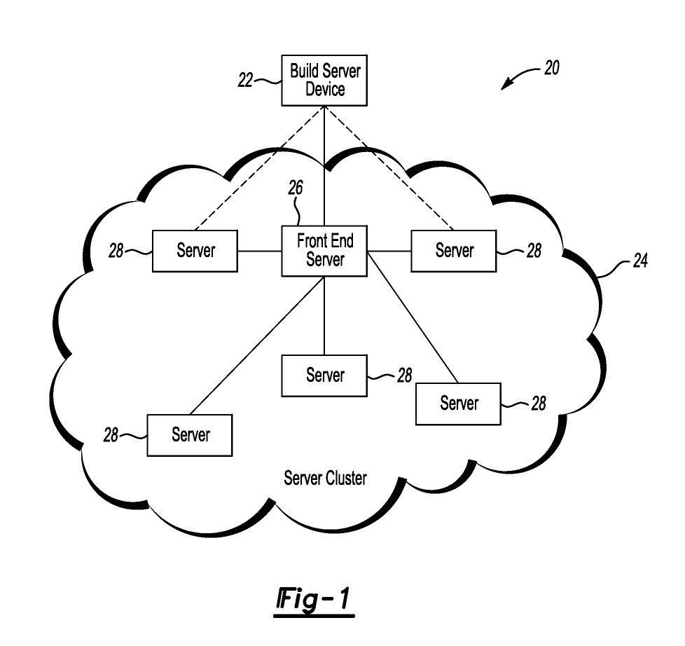

FIG. 1 schematically illustrates selected portions of a server cluster computing system 20. A build server device 22, which is a server cluster initiator device, is configured to facilitate automatic initiation of a server cluster 24. The illustrated example server cluster 24 includes a front end server 26 and a plurality of other servers 28. The front end server 26 is configured to operate, for example, as an interface between the other servers 28 and computing devices outside of the server cluster 24 in a generally known manner once the server cluster 24 is fully installed (e.g., initiated and operational for providing computing services to one or more users). During the installation or initiation process, the front end server 26 may also serve as an interface between the build server device 22 and the various servers 28 within the server cluster 24.

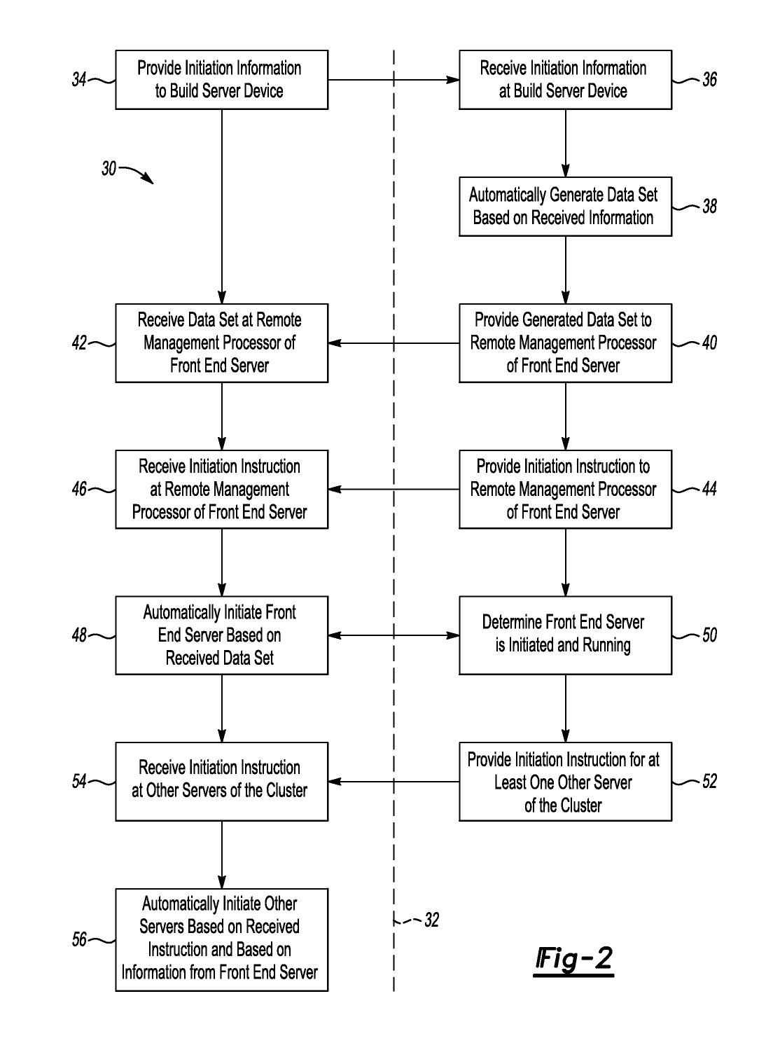

An automated initiation process is summarized in the flowchart diagram 30 of FIG. 2. The illustration includes a dividing line 32 that schematically divides the example process between a portion on the left side of the dividing line 32 that is performed by or involves one or more devices in the server cluster 24 and a portion on the right side of the dividing line 32 that is performed by or involves the build server device 22.

At 34, an individual or entity desiring to install the server cluster 24 provides initiation information to the build server device 22. In one example, the client or individual uses a web server or application programming interface (API) calls to provide the initiation information. In one example, the initiation information includes an identifier and Internet Protocol address of at least the front end server 26 and a list of remote management processors associated with the other servers 28 in the server cluster 24. One example includes providing an IP address for a remote management processor associated with each of the servers 28 and the front end server 26, respectively. Additional information regarding how the server cluster 24 is to be configured to operate is included in the initiation information in some examples. The portion of the process represented at 34 is the only portion in this example that requires any manual intervention. The remainder of the process is fully automated.

At 36, the build server device 22 receives the initiation information. The build server device 22 in one example interprets the received initiation information as a request to facilitate an automated initiation of a server cluster. The build server device 22 is a computing device including a processor and associated data storage. The build server device 22 also includes a plurality of modules for facilitating the automated server cluster initiation process. In some examples, a module may be realized utilizing hardware or firmware of the processor portion of the build server device 22. In other examples, one or more of the modules may be realized through software stored in the data storage. For example, the build server device 22 includes a receiving module, a generating module and an initiation module. The receiving module is configured to receive the initiation information as represented at 36 in FIG. 2.

The generating module is configured to generate a data set based on the received initiation information. This is shown at 38 in FIG. 2. In some examples, the generated data set comprises an image such as an ISO format image that is based on the initiation information. Using an image facilitates, for example, the front end server 26 treating the image as if it were a disk to be read or used by the front end server 26 during a boot up procedure.

At 40, the initiation module of the build server device 22 provides the generated data set to a remote management processor of the front end server 40. In one example, this is accomplished using an API call to the remote management processor of the front end server 26. The generated data set (e.g., an ISO format file) is received and mounted to the front end server at 42.

At 44, the initiation module provides an initiation instruction to the remote management processor of the front end server 26. At 46, the initiation instruction is received. API calls between the build server device 22 and the remote management processor of the front end server 26 facilitate the communication of the initiation instruction to the front end server 26 according to one example embodiment.

As shown at 48, the front end server 26 is turned on based upon the initiation instruction and configured to boot from the data set (e.g., ISO file) that has already been provided by the build server device 22. The build server device 22 in this example provides an operating system and various configuration parameters to the front end server 26 according to the information provided at 34. As shown at 50, the build server device 22 determines when the front end server 26 is initiated and running The build server device 22 in some examples receives a notification from the front end server 26 regarding its operational status once the front end server 26 is up and running In some examples, the build server device 22 uses remote monitoring or signaling techniques to assess the status of the front end server 26.

Once the front end server 26 is up and running, an initiation instruction is provided at 52 to the other servers 28 of the server cluster 24. The initiation instruction for the other servers 28 is provided to a remote management processor of each of the other servers 28 that is to be initiated. In one example, the build server device 22 communicates the initiation instruction for the other servers 28 directly to the remote management processors of the other servers 28, respectively. In another example, some of the initiation instructions are provided to some of the other servers 28 by the build server device 22 while others of the initiation instructions are provided to some of the other servers 28 by the front end server 26.

At 54, an initiation instruction is received at the other servers 28. At 56, the other servers are automatically initiated based on the received initiation instruction, which includes an instruction to the other servers 28 to boot from information provided by the front end server 26. During the initiation of the other servers 28, the front end server 26 provides an Internet Protocol address to each of the other servers 28 and operational information that facilitates the servers 28 eventually operating as the cluster 24. In the illustrated example, the front end server 26 also installs an operating system on each of the other servers 28. One example includes using a pre-boot execution environment protocol for communications between the front end server 26 and the other servers 28. Data provided to the other servers 28 may be provided to the front end server 26 with the original data set from the build server device 22 or it may be provided in a more dynamic fashion (e.g., in an ongoing fashion while the others servers 28 are being initiated).

Once a desired number of the other servers 28 has been initiated, the server cluster 24 may be considered to be fully installed and operational for purposes of providing computing services to one or more users who will have access to the server cluster 24. The process of initiating the server cluster 24 is fully automated with the exception of the portion of the process represented at 34 where an individual or entity provides initiation information and makes a request to begin the automated process.

Fully automating the server cluster initiation process essentially eliminates the complexity and significantly reduces the time commitment that otherwise was associated with such a process. Additionally, the fully automated process described above reduces or minimizes the likelihood for errors associated with manual entry or manual configuration of a device during the initiation process.

The preceding description is illustrative rather than limiting in nature. Variations and modifications to at least one disclosed example may become apparent to those skilled in the art that do not necessarily depart from the essence of the contribution to the art provided by the disclosed example. The scope of legal protection can only be determined by studying the following claims.

We claim:

1. A build server device, comprising:
a processor;
data storage associated with the processor; and
a plurality of modules, each of the modules being a portion of at least one of the processor or the storage, the plurality of modules including
a receiving module that is configured to receive information regarding a server cluster including at least an indication of a front end server of the server cluster;
a generating module that is configured to generate a data set based on the received information; and
a initiation module that is configured to
provide the generated data set to the front end server, and
provide an instruction to the front end server to facilitate the front end server automatically initiating itself based on the generated data set.

2. The device of claim 1, wherein
the received information identifies the front end server and other servers in the server cluster; and
the initiation module is configured to provide an instruction to the other servers in the server cluster to facilitate the other servers initiating themselves based on information from the front end server.

3. The device of claim 2, wherein the generated data set includes information that facilitates configuring the other servers in a manner corresponding to the other servers operating as the server cluster.

4. The device of claim 1, wherein the received information includes
an address of a remote management processor of at least the front end server,
an address of a remote management processor of at least one other server of the server cluster, and
parameters indicative of how the server cluster is to be initiated.

5. The device of claim 1, wherein the generated data set comprises an image corresponding to the received information and information that server cluster initiation is to be based upon.

6. The device of claim 5, wherein the initiation module is configured to
cause the image to be mounted to the front end server, and
instruct the front end server to boot from the image.

7. A server cluster system, comprising:
a front end server including a front end remote management processor that is configured to receive a data set from a build server device and to initiate the front end server based on the received data set; and
a plurality of other servers, each including a remote management processor that is configured to receive an initiation instruction to initiate the other server based on the instruction and based on information from the front end server.

8. The system of claim 7, wherein the front end server and the other servers are initiated in a fully automated manner based on the received information and initiation instructions.

9. The system of claim 7, wherein the front end server provides an address and an operating system to the other servers.

10. The system of claim 7, wherein the remote management processors of the other servers receives the instruction to initiate from the build server device.

11. The system of claim 7, wherein the received data set comprises
an image corresponding to information which at least initiation of the server cluster system is to be based upon, and
at least an identifier of each of the other servers.

12. The system of claim 7, wherein the remote management processor of the front end server is configured to treat the received data set as a boot up disc from which to boot the front end server.

13. The system of claim 7, wherein the front end server is configured to provide an indication of the front end server being initiated and operational to the server cluster initiator device.

14. A method of initiating a server cluster, comprising the steps of:
receiving information regarding a server cluster including at least an indication of a front end server of the server cluster;
automatically generating a data set based on the received information;
automatically providing the generated data set to the front end server; and
automatically providing an instruction to the front end server to facilitate the front end server initiating itself based on the generated data set.

15. The method of claim 14, wherein the received information identifies the front end server and a plurality of other servers in the server cluster and the method comprises providing an instruction to the other servers in the server cluster to facilitate the other servers initiating themselves based on information from the front end server.

16. The method of claim 14, wherein generating the data set comprises generating an image corresponding to the received information and information that server cluster initiation is to be based upon.

17. A method of initiating a server cluster system, comprising the steps of:
receiving a data set at a front end server of the server cluster;
automatically initiating the front end server based on the received data set;
receiving an initiation instruction at a plurality of other servers of the server cluster; and
automatically initiating the other servers based on the received initiation instruction and based on information from the front end server.

18. The method of claim 17, comprising
providing an address and an operating system from the front end server to the other servers, respectively.

19. The method of claim 17, wherein
the received data set comprises an image corresponding to information which at least initiation of the server cluster system is to be based upon, and at least an identifier of the other servers; and
the method comprises the front end server treating the received data set as a boot up disc from which to boot the front end server.

20. The method of claim 17, wherein
receiving the data set at the front end server comprises receiving an application programming interface protocol call at a remote management processor of the front end server; and
receiving the initiation instruction at the plurality of other servers comprises receiving an application programming interface protocol call at a remote management processor of the other servers, respectively.
